(19) United States
(12) Patent Application Publication
(10) Pub. No.: US 2007/0253032 A1
(43) Pub. Date: Nov. 1, 2007

(54) Systems and Methods for Simultneous and Automatic Digital Images Processing

(76) Inventors: Moshe Keydar, Holon (IL); Ilana Keydar, Holon (IL)

Correspondence Address: IIana Keydar, 109 Histadrt Street, Holon, 58347, IL

(21) Appl. No.: 11/661,861

(22) PCT Filed: Oct. 9, 2005
(86) PCT No.: PCT/IL05/01068

§ 371 Date: Mar. 5, 2007

Related U.S. Application Data
(60) Provisional application No. 60/621,650, filed on Oct. 26, 2004.

(51) Int. Cl. G06T 5/00; G06K 9/46

(52) U.S. Cl. 358/3.27; 382/190

(57) ABSTRACT

The systems and methods of the present invention enable the simultaneous and automatic corrections of digital images. The systems and methods of the present invention contain an Intelligent Expert-System (IES) for processing a single digital image, selected group of digital images and a batch of digital images. The expert-system analyzes each digital image automatically, independent of any other images, extracting plurality of image characteristics, and performing image quantifications and classifications. The digital image is then corrected using fuzzy logic techniques, according to the quantifications of the various characteristics and the expert-system rule base and knowledge base. The expert system components can be customized in respect to subjective user definition and criteria.

### FIELD OF THE INVENTION

The present invention is related to the field of digital photofinishing, digital imaging, online photography, and home color digital imaging devices and to the field of rule-base expert-systems. More specifically, the present invention relates to utilizing rule-base expert-system technology and fuzzy logic techniques to enable simultaneous and automatic correction of digital images.

### BACKROUND OF INVENTION

The digital Photofinishing systems, the online Photography systems and the home color printers use digital images. Digital images are created by a digital camera or by a scanner, which scans films or photographs. These images are processed as following:
Traditional Photofinishing systems use the films directly to produce the photo prints. A film holds analog images data, obtained by a film camera. In the film digital workflow, the Photofinishing system scans the film to first produce digital images. The digital images are then processed and printed on the Photofinishing printer.
The digital (without films) Photofinishing workflow uses digital images created mostly by digital cameras. Similarly to the previous case, the digital images have to be processed and printed on the Photofinishing printer.
An online Photography service, prepares Photo prints from digital images obtained through the Web (or other communication channels).
For home users, the digital images can be printed on home color printers using photo paper.

In all the above cases, in order to obtain high quality photo prints or visual displays, there is a need to process the digital images. There is a need to perform operations on every digital image, in order to:
1) Correct the image deficiencies introduced by the camera sensors and camera operator (light conditions, focus problems . . . etc.).
2) Recalculate the image color data and prepare it for the printing process, by making adjustments to compensate for the differences between the color characteristics of the digital image creator (film type, scanner or digital camera) and the color characteristics of the printer and the paper type.
3) To recalculate the image color data and prepare it for the printing process, by making adjustments to compensate for the differences between the color characteristics of the digital image creator (film type, scanner or digital camera) and the color characteristics of the display device.

The above operations require a complicated analysis of each digital image, which usually requires professional knowledge of a graphic art expert.

In most cases, especially in a production environment, there is a large number of images to be processed in each set. Such operations require a fully automated solution with no human interference or manipulation. The variety of film types, scanner types, digital camera types, printer types and paper types require an intelligent automatic system, which can be controlled within the Photolab production process.

In the digital age, the number of digital images created, stored, displayed and stored every day, is growing exponentially; also, many types of digital images are available. The need for a fully automatic system is enhanced by the fact that it is impossible for a human operator, amateur or professional, to manually manipulate and correct all created digital images.

### SUMMARY OF THE INVENTION

It is thus the object of the present invention to provide systems and methods which utilize expert-system technology to enable the simultaneous and automatic processing of digital images in order to adjust and optimize the digital images and prepare them for printing or viewing.

Another object of the present invention is to provide automatic methods for intelligent analysis of digital images. Each image is analyzed automatically and independently of other images, for a plurality of image characteristics, and quantification of those characteristics. The expert system automatically classifies each image, using the image characteristics, according to empirically acquired expert-system rule-base and expert-system knowledge base.

The digital image is then corrected according to the image classification and the image characteristics quantification, using fuzzy-logic techniques and the expert-system knowledge base.

It is yet another object of the present invention to provide methods and tools to customize the expert-system with respect to the subjective user definitions of digital the image quality criteria. It is still another objective of the present invention to enable the automatic execution of different equipment setups like: the digital images output device (printer type, screen type), paper type and the digital images input device (camera type).

In particular, it is the objective of the present invention to enable the execution of correcting the digital image deficiencies and recalculation of the image color data, on a particular image, selected group of images and large number of images defined as a set (a batch of images).

### BRIEF DESCRIPTION OF DRAWINGS

FIG. 1 is a schematic representation of the architecture of first embodiment of the present invention.

FIG. 2 is a schematic representation of the architecture of second embodiment of the present invention.

FIG. 3 depicts an exemplary application using the first embodiment of the system of the present invention.

FIG. 4 depicts an exemplary application using the second embodiment of the system of the present invention.

FIG. 5 depicts an exemplary application using the third embodiment of the system of the present invention.

FIG. 6 is a schematic representation of the Customization Interface blocks.

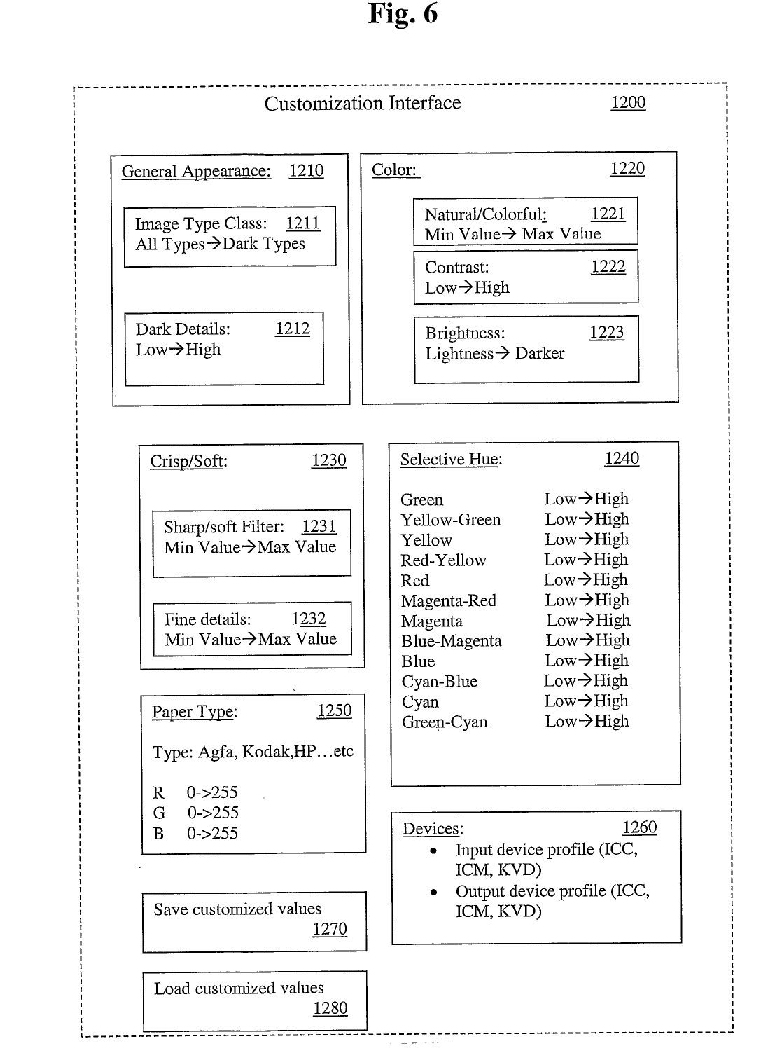

### LIST OF ABBREVIATIONS COMMONLY USED IN THIS DOCUMENT

IES=Intelligent Expert System
Digital Image=Image, photograph, photo, picture
Min=Minimal
Max=Maximal
CPU=Central Processing Unit
RAM=Random Access Memory
ESS=Expert System Settings

### DETAILED DESCRIPTION OF THE INVENTION

The systems and methods of the present invention are intended to overcome the shortcomings of existing digital image correction tools used by digital photofinishing systems, online photography systems and home color printers/displays. While all existing tools need the intervention of a manual operator in order to correct a wide variety of possible characteristics of the images, the present invention provides a system that enables a simultaneous and a fully automated digital image correction of a plurality of images which can be of large quantity, a few selected images or a single image.

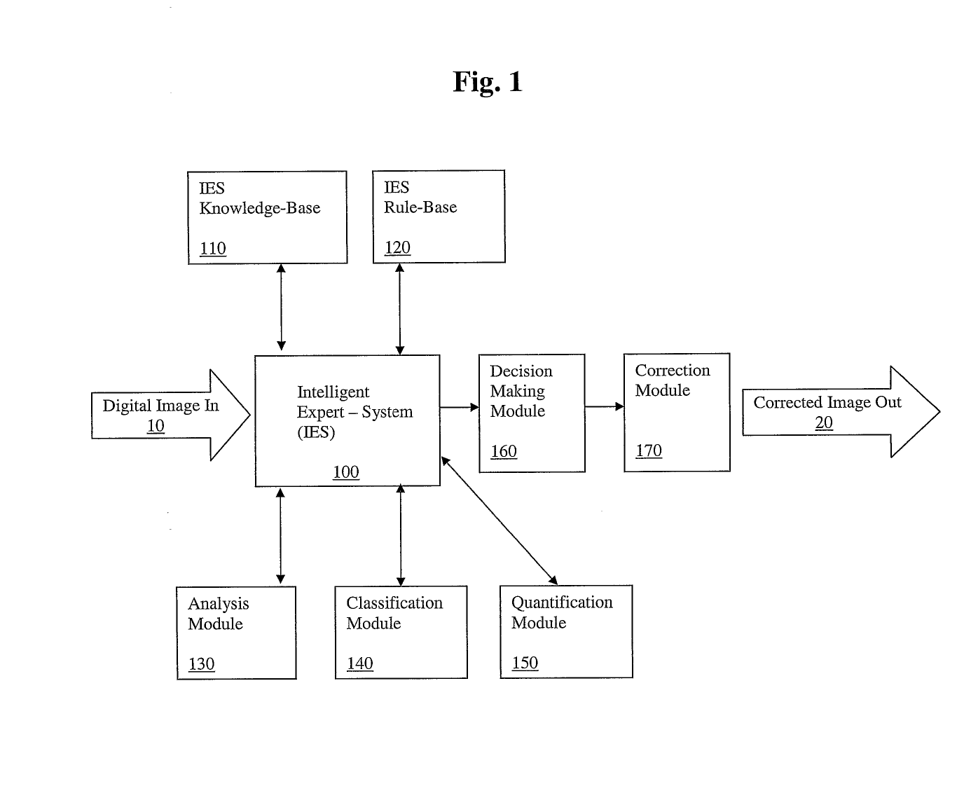

FIG. 1 describes the basic architecture of the present invention. At the core of the present invention is an Intelligent Expert-System (IES) 100, the IES Knowledge-base 110 and the IES Rule-base 120. The IES uses fuzzy logic techniques in order to simultaneously and automatically correct digital images.

The digital image appearance criterion is defined subjectively by a particular human visual system. The expert system 100 is driven by an external set of parameters, which is part of the knowledge base 110, that defines the subjective human visual system preferences in term of: General appearance (all types . . . dark type), Color (natural . . . colorful), contrast, brightness, Crisp (sharp) or soft, Hues . . . and so on and so forth.

In the system of the present invention, which uses the architecture illustrated in FIG. 1, the expert system external parameters are set to default values, which are a result of a long empirical study on thousands of digital images.

The Analysis Module 130 analyzes every input image 10 for a plurality of image characteristics, the Quantification Module 150 quantifies each image characteristic and the digital image is classified by the Classification Module 140 as image of a specific type.

The IES is using the input from 130, 140 & 150 regarding the input image 10, and the expert system knowledge-base 110 & rule-base 120 as input to the Decision Making Module 160. The decision regarding which of the image characteristics need to be corrected, and how much correction should be applied, occur at this stage by the Decision Making Module 160. The result is a sequence of operations on the original (input) image 10, which are performed by the Correction Module 170, in order to improve the quality of image 10, as seen by the observer on the final Print or on the Viewing device.

In FIG. 1, the expert system 100 makes a decision regarding the needed operations on the input digital image 10 according to the input image characteristics and IES external default parameters, as explained before. The result is a new improved image that satisfies the human observer and the set of rules as defined by the IES.

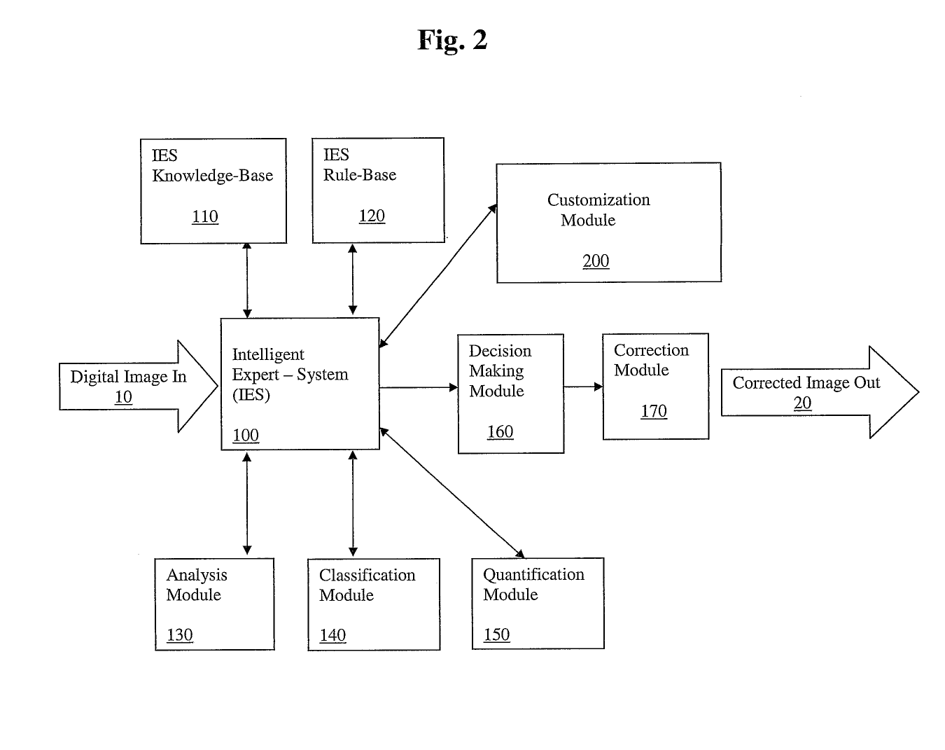

FIG. 2 describes the architecture of a more sophisticated embodiment of the present invention that enables the user to control the performance of the expert system, and the quality of the result. In this embodiment, a Customization Module 200 is added to the basic architecture described in FIG. 1 in order to allow the user the ability to customize the IES parameters to fit his quality needs or liking.

The Customization Module 200 translates the user's image quality preferences to expert-system's image characteristics. Those preferences are considered at the Decision Making Module 160, whenever decisions regarding which image characteristics are to be corrected, and how much correction should be applied. The result is a sequence of operations on the input image 10, which are performed at the Correction Module 170, in order to improve the input image quality to match the user's need or liking, as seen in the Printing or on the Viewing device.

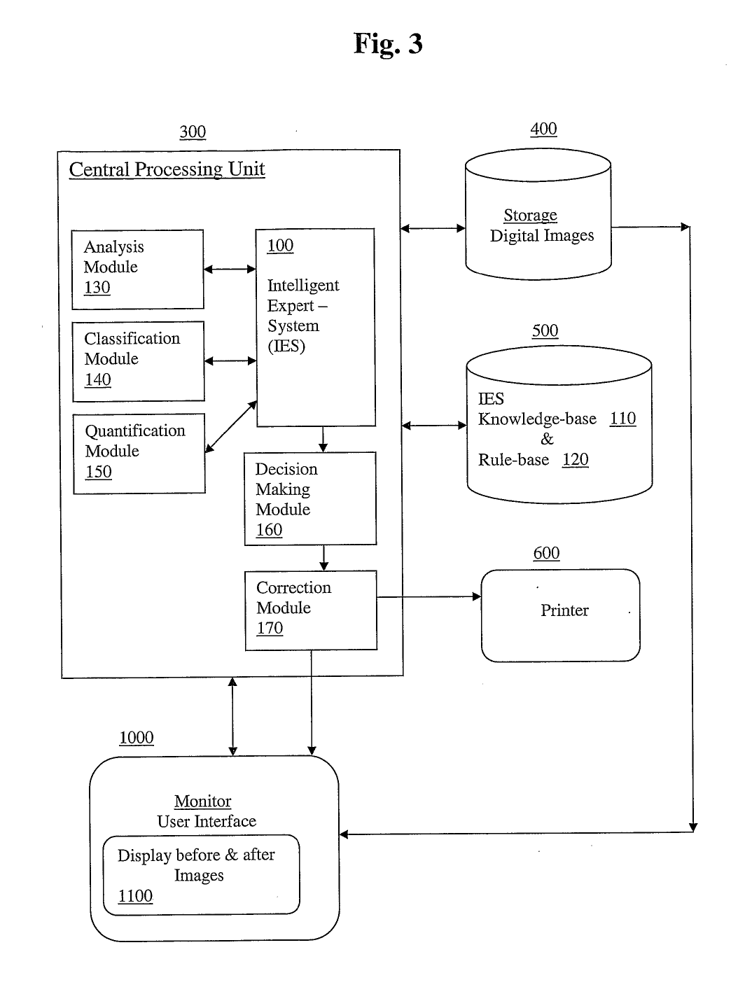

FIG. 3 describes an exemplary application using the first embodiment of the system of the present invention. Sets of digital images are stored in any storage media 400: hard disk, disk on key, smart card, RAM . . . etc. Any input device such as a digital camera or scanner can create the digital images. The images final destination is a printer 600 or a Viewing device such as monitor 1000. The IES 100 and the accompanying modules 130, 140, 150, 160 & 170 are running on any CPU 300, read the input digital images from storage 400 and perform the digital image correction according to first embodiment of this invention as described in FIG. 1. The expert system Knowledge-base and Rule-base are stored on any fast accessible storage media 500 such as a hard disk, RAM or flash memory.

The viewing monitor 1000 displays both original digital image and the corrected digital image 1100, and the user can choose whether to save in storage 400 the corrected image or not.

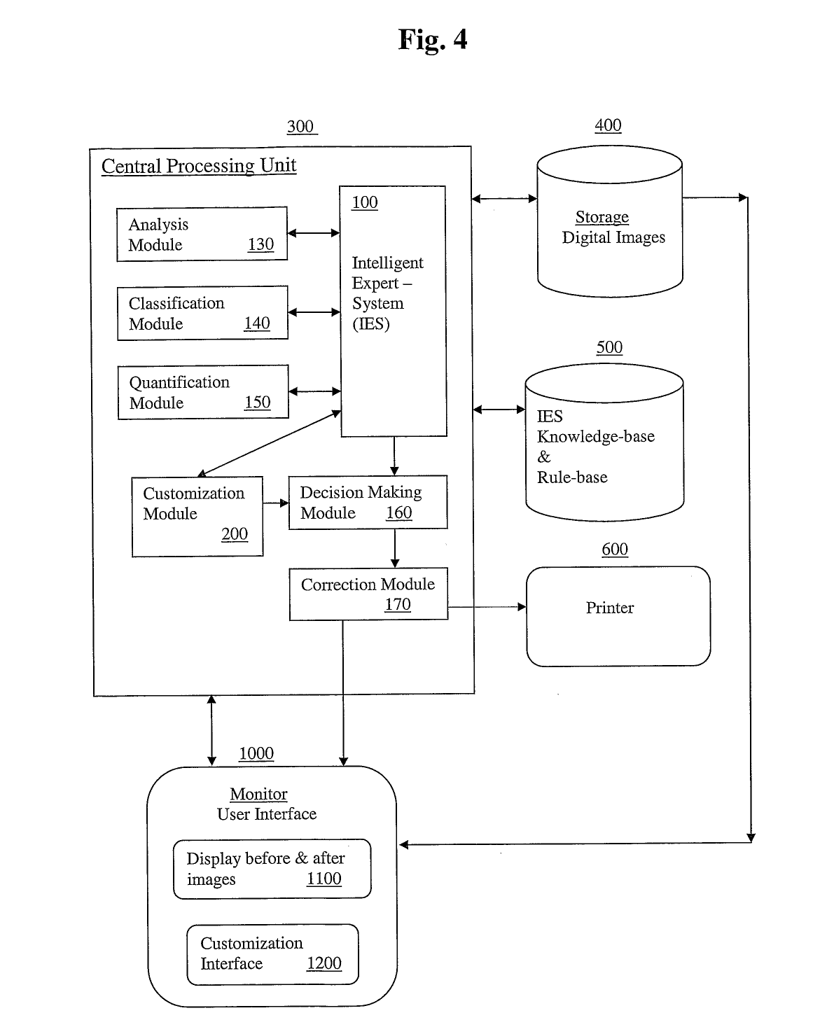

FIG. 4 describes an exemplary application using the second embodiment of the system of the present invention. In this embodiment a Customization Module 200 and a Customization Interface 1200 are added to the system described in FIG. 3 in order to enable the user the ability to customize the IES parameters to fit his image quality needs or liking. The Customization Interface 1200 gives the user the means to update the various IES parameters.

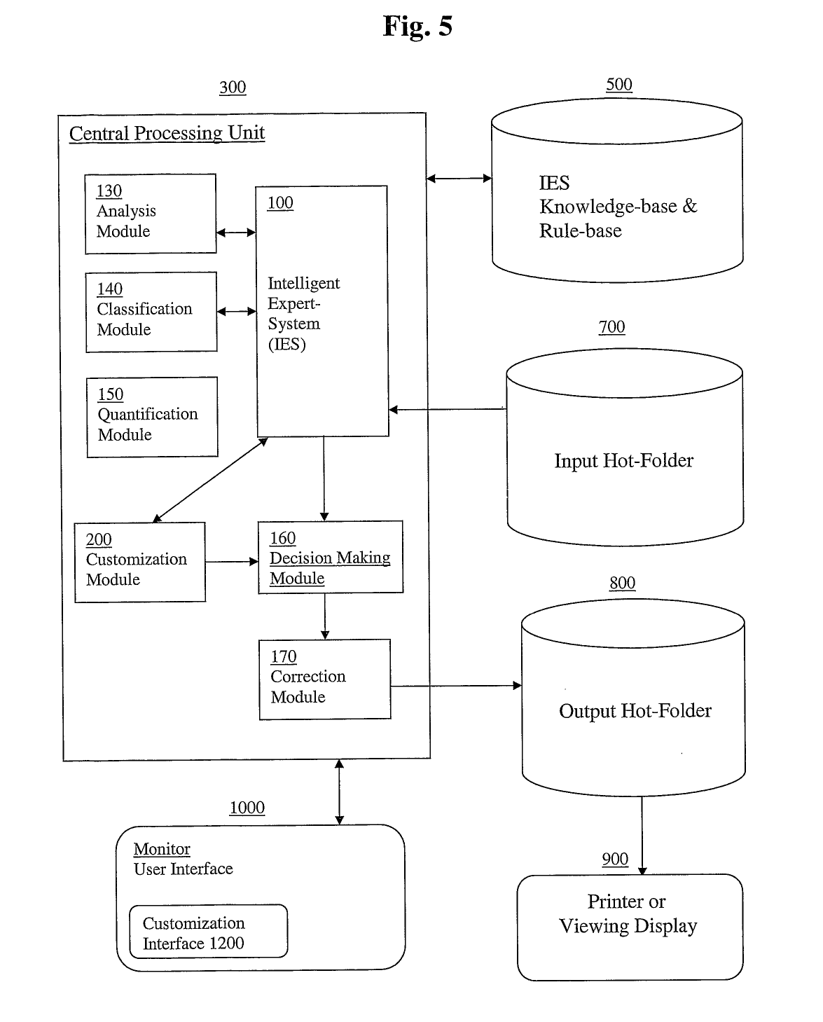

FIG. 5 describes an exemplary application using the third embodiment of the system of the present invention. In this embodiment an Input Hot Folder and an Output Hot Folder are added to the system described in FIG. 4. The IES is picking every new image which enter the input Hot Folder, corrects the new image and put the new corrected image in the output Hot Folder.

Image quality is subjective, and various people may have different quality and taste criteria. In addition, various printers, even from the same manufacturer, print the same digital image differently. Thus, the present invention enables the user to change the digital image characteristics according to his liking. The Customization Interface that is described in FIG. 5 enables the customization of the image quality according to the user's preferences. The Customization Interface includes quality image characteristics (or settings), which are very natural to the human visual perception. Image characteristics like ‘General Appearance’ 1210 that allow the selection of ‘Image Type Class’ 1211 that varies from ‘All Types’ images to ‘Dark Type’ images, and the ‘Dark Details’ 1212 characteristic that varies from ‘low’ details to ‘high’ details. This setting enables the correction of ‘Dark Details’ of a specific type of images as selected by the user (the ‘Image Type’ class 1211) and the weight of the correction (the ‘Dark Detail’ 1212).

The ‘Color’ quality characteristic 1220 enables the amount of the colorfulness ‘Natural/Colorful’ 1221 of the image, the ‘Contrast’ 1222 and the ‘Brightness’ 1223, by setting a value between Min to Max. Other quality characteristics like: ‘Crisp/Soft’ 1230 enable to choose if the image will look crisp (sharp) or soft (smooth) and ‘Selective Hue’ 1240 that enable to change the image hues.

All above settings are derived from the image content and how the user would prefer the images to look like.

The Customization Interface 1200 contains also ‘Paper Type’ 1250 setting interface and ‘Devices’ 1260 setting interface. The ‘Paper type’ 1250 offers the user the possibility to consider various paper types defined by RGB values (can receive negative values too). The ‘Devices’ setting enable the upload of the source (Digital Camera, Scanner . . . or other) and destination (Printer, Monitor . . . or other) device profiles. The profiles can be ICC, ICM or propriety device profiles.

The Customization Interface 1200 enables more detailed view for images taken on bad conditions, it can be used for: aerial, low light, surveillance, security and biology/medical research photos.

The ‘Save Customized Values’ 1270 interface enables saving the new customized settings in an ESS (Expert System Settings) disk file. The ESS file can be used later as a generic setting that describes the user desired look of the images. A set of predefined various settings represent different type of users preferences. The ESS files can be sent via email or other method to other stations, which run the system or apparatus of the present invention. The ‘Load Customized Values’ 1280 interface enables loading a previously created ESS file to be used with coming sets of photos. The user can define his preferred image quality by generic naming like: Natural, Colorful . . . and others, for every such name a corresponding ESS file is created and saved.

The Photofinishing station: kiosk/retail/online/home presents to the user by a user interface or an envelope, a set of flavors with empty checkmarks, to be filled by the user. Those settings are used by the IES later.

The ESS files enable REMOTE control on printing/viewing devices that include an application of the current invention.

The invention being thus described in terms of preferred embodiment and examples, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for simultaneous and automatic digital image correction comprising the steps of:
Providing an Intelligent Expert-System, expert-system rule-base and expert-system knowledge base; also providing the following modules:
a) Analysis module
b) Classification module
c) Quantification module
d) Decision Making module
e) Correction module
Inputting a digital image to the said Intelligent Expert-System, analyzing the said digital image and extracting the said image characteristics. Classifying the said image type and quantifying said image characteristics.
The said Intelligent Expert-System is using fuzzy logic technique and said quantified image characteristics and said image classification result, the expert-system rule-base and the expert-system knowledge-base to make a decision regarding which said image characteristics to correct, and the weight of the correction. Said image is corrected simultaneously and automatically according to said decision.
The said steps can be repeated on plurality of images, on a selected number of images or on a single image.

2. The method of claim 1, additionally comprising the means for customizing the image characteristics to specific customization flavor and liking.

3. The method of claim 2 additionally comprises Customization module; and additionally comprising, after said step of quantifying said image characteristics a step of customizing image characteristics to specific customization flavor. The said Intelligent Expert-System is using fuzzy logic technique and said quantified characteristics and said image classification result, the expert-system rule-base, expert-system knowledge-base and customized characteristics to make a decision regarding which characteristics to correct, and the weight of the correction. Said image is then corrected according to said decision. The said steps can be repeated on plurality of images, on a selected number of images or on a single image.

4. A simultaneous and automatic digital image correction system comprising an Intelligent Expert-System, an expert-system rule-base and an expert-system knowledge base; also comprising the following modules:
a) Analysis module
b) Classification module
c) Quantification module
d) Decision Making module
e) Correction module
Inputting a digital image to the said Intelligent Expert-System, analyzing the said digital image and extracting the said image characteristics. Classifying the said image type and quantifying said image characteristics.
The said Intelligent Expert-System is using fuzzy logic techniques and said quantified image characteristics and said image classification result, the expert-system rule-base and the expert-system knowledge-base to make a decision regarding which said image characteristics to correct, and the weight of the correction. Said image is corrected simultaneously and automatically according to said decision.
The said steps can be repeated on plurality of images, on a selected number of images or on a single image.

5. The system of claim 4, additionally comprising one or more storage devices connected with said Intelligent Expert-System.

6. The system of claim 4, additionally comprising the means for reading the image from the storage devices in claim 5.

7. The system of claim 4, additionally comprising one or more printing devices connected with said Intelligent Expert-System.

8. The system of claim 4, additionally comprising the means for printing the corrected on the printing device as in claim 7.

9. The system of claim 4, additionally comprising one or more viewing devices connected with said Intelligent Expert-System.

10. The system of claim 4, additionally comprising the means for displaying the input and corrected images on the viewing device as in claim 9.

11. The system of claim 4, additionally comprising the means for customizing the image characteristics to specific customization flavor and liking.

12. The system of claim 5 additionally comprises Customization module; and additionally comprising, after quantifying said image characteristics a step of customizing image characteristics to specific customization flavor. The said Intelligent Expert-System is using fuzzy logic technique and said quantified characteristics and said image classification result, the expert-system rule-base, the expert-system knowledge-base and customized characteristics to make a decision regarding which characteristics to correct, and the weight of the correction. Said image is then corrected according to said decision. The said steps can be repeated on plurality of images, on a selected number of images or on a single image.
